(19) United States
(12) Patent Application Publication
(10) Pub. No.: US 2015/0356275 A1
(43) Pub. Date: Dec. 10, 2015

(54) System and Method for Eliciting Patient Engagement Corresponding to an Engagement Plan

(71) Applicant: COHERE HEALTH TECHNOLOGIES, LLC, NEW YORK, NY (US)

(72) Inventors: CLAY WILLIAMS, NEW YORK, NY (US); MICHAEL ROGAN, NEW YORK, NY (US)

(73) Assignee: COHERE HEALTH TECHNOLOGIES, LLC

(21) Appl. No.: 14/731,012

(22) Filed: Jun. 4, 2015

Related U.S. Application Data
(60) Provisional application No. 62/008,802, filed on Jun. 6, 2014.

(51) Int. Cl. G06F 19/00

(52) U.S. Cl. CPC G06F 19/363

(57) ABSTRACT

A processor-implemented system and method is provided for monitoring patient parameters of engagement plans administered to patients. A builder software application on a first processor-based device is provided for creating an engagement plan from an engagement protocol. An engagement software application on the first processor-based device is configured for monitoring the engagement plan to determine that an administering time for administering the engagement plan has been reached. The engagement software application is further configured for generating a notification message when it is determined that the administering time has been reached. The notification message is transmitted to a registered second processor-based device. The notification message includes an interactive software component for receiving a response message from the second processor-based device. The engagement software application is configured to receive the response message and a status, and to determine patient parameters, thereby engaging patients corresponding to the administered engagement plan.

### RELATED APPLICATION

This application is related to, cross-references, and claims priority from U.S. provisional application 62/008,802, filed on Jun. 6, 2014, the disclosure of which is incorporated by reference herein.

### FIELD

The present disclosure relates in general to the field of automated monitoring of medical engagement plans administered to patients, and specifically to a processor-implemented system and method for eliciting patient engagement corresponding to an engagement plan in accordance with interactive messages sent from a server to elicit patient engagement and responses received from a remote device corresponding to the patient.

### BACKGROUND

Communication of relevant information between patients and health care professionals (HCPs) is an important driver of health outcomes. Medical facilities and providers may communicate to educate patients and to make informed decisions about medical testing, diagnosis, treatment design, and treatment implementation. Following diagnosis, communication continues to be essential in order to track symptoms, treatment compliance and efficacy, behavioral changes, and other related developments.

In certain applications, the current focus is typically in the space of patient engagement. However, the primary focus appears limited to collaboration among providers, and among the patients and their respective caregivers. For example, some applications focus on areas related to the creation of plans for care, monitoring the plans and raising alarms when performance is below a threshold, and reporting on plan status. However, these applications relate to thresholds of performance rather than patient engagement that is beyond a general status check.

In other applications, the space of text messaging using short-messaging-systems (SMS) is used for communication between patients and providers. Such applications may relate to instructions for an appointment, such as an upcoming appointment or reminders concerning actions from a completed appointment. However, such applications limit interaction to suggestions about pre-appointment preparation (e.g. fasting for 8 hours before the appointment) or post-appointment action (e.g. removing a dressing at a particular time). These are general interactions based on a plan. Alternative applications may deal with post-visit evaluation of a patient's experience, their understanding of a diagnosis made, and their intent to comply. However, this is not a routine and current methodology and relates to specific aspects of the visit. Furthermore, these interactions do not offer a structured and interactive mode for gathering data that can then be analyzed by computers.

Certain other applications also provide software tools for collection of data from patients, including capturing information related to a healthcare situation. However, this is limited to collecting data from a measurement device, rather than data authored by the patient themselves. For example, fitness tracker, glucoses monitors, blood pressure monitors, and wireless weight scales, each of which transmit data collected by the device that patient input. Furthermore, such applications may provide integration and use of clinical data via patient portals. In such applications, patients are manually engaged to provide information. In some cases, these applications include software tools for engaging patients according to a care plan. However, most of these applications provide patient engagements via audio and video interaction with very limited interactivity (e.g., the level of interaction is only as much as supported by modern cable TV remote controls). Such applications also lack structure structured, interactive engagements, and mobility.

In some cases, applications have been deployed to monitor patient behavior via sensors and to provide recommendations unrelated to a plan. There are broad spectrum applications that connect physicians to patients but there is no on-going engagement or support that relates to providing interaction between visits to the physician.

### SUMMARY

The present disclosure provides a processor-implemented system and method for eliciting patient engagement corresponding to an engagement plan in accordance with interactive messages sent from a server and responses received from a remote device corresponding to the patient, in accordance with an exemplary implementation.

One aspect of the disclosure herein provides for a processor-implemented system for eliciting patient engagement corresponding to an engagement plan administered to the patient. A builder software application executing on a first processor-based device is provided for creating the engagement plan corresponding to the patient by customizing an engagement protocol from a protocol from a database of engagement protocols. Each of the engagement protocols typically relates to a type of medical condition. An engagement software application executing on the first processor-based device is configured for monitoring the engagement plan relating to the patient to determine that an administering time for administering the engagement plan has been reached. The engagement software application on the first processor-based device is further configured for generating a notification message for a notification server queue when it is determined that the administering time has been reached. Further, the notification message corresponds to the engagement protocol of the engagement plan. The notification server queue is configured for transmitting the notification message to a registered second processor-based device. The notification message includes an interactive software component for receiving a response message from the second processor-based device. The response message or a lack of the response message optionally initiates one or more follow-up notification messages to be sent to the second processor-based device. The engagement software application on the first processor-based device is also configured to receive the response message and a status corresponding to the notification message and the response message. Further, the engagement software application is configured to determine patient parameters in accordance with the response message and the status, thereby eliciting patient engagement corresponding to the engagement plan.

Another aspect of the disclosure herein is a processor-based method for eliciting patient engagement corresponding to an engagement plan administered to the patient. The processor-based method includes a creating function, on a builder software application executing on a first processor-based device, for creating the engagement plan corresponding to the patient by customizing an engagement protocol from a database of engagement protocols. Each of the engagement protocols typically relates to a type of medical condition. A monitoring function, by an engagement software application executing on the first processor-based device, performs monitoring of the engagement plan relating to the patient to determine that an administering time for administering the engagement plan has been reached. When it is determined that the administering time has been reached, a generating function, by the engagement software application on the first processor-based device, provides a notification message for a notification server queue. The notification message corresponds to the engagement protocol of the engagement plan. A transmitting function, from the notification server queue, transmits the notification message to a registered second processor-based device. The notification message includes an interactive software component for receiving a response message from the second processor-based device. Further, the response message or a lack of the response message optionally initiates one or more follow-up notification messages to be sent to the second processor-based device. A receiving function, by the engagement software application on the first processor-based device, receives the response message and a status corresponding to the notification message and the response message. A determining function, by the engagement software application on the first processor-based device, determines patient parameters in accordance with the response message and the status, thereby eliciting patient engagement corresponding to the engagement plan.

### BRIEF DESCRIPTION OF THE DRAWINGS

The accompanying figures, which are included as part of the present specification, illustrate the various implementations of the presently disclosed system and method and together with the general description given above and the detailed description of the implementations given below serve to explain and teach the principles of the present system and method.

FIG. 1 illustrates an exemplary system for eliciting patent engagement corresponding to an engagement plan in accordance with interactive messages sent from a server and responses received from a remote device.

FIG. 2 illustrates an exemplary flowchart for a method for eliciting patent engagement corresponding to an engagement plan in accordance with interactive messages sent from a server and responses received from a remote device.

### DETAILED DESCRIPTION

An exemplary software and hardware system and method is disclosed for use by patients, caregivers and health care professionals (HCPs) to support health management and improve health outcomes by facilitating communication of clinically relevant information during the time between office visits. The exemplary communication system and method herein allows patient engagement between HCPs and patients, to meaningfully engage on a regular basis through digital messages and responses, and this can greatly incentivize patient self-care. In certain exemplary aspects, the messages may include queries, reminders, notifications, and requests delivered via an electronic medium. Further, the exemplary system herein uses digital messages to support health care management by developing and facilitating patient's health; supporting awareness and behaviors through scheduled messages from the HCP; supporting the elicitation, recording, communication, and analysis of clinically relevant information about patient health, including symptoms, emotional state, behavior; and supporting HCP's management of patient health through the use of expertly designed customizable plans for automated, software effected, two-way communication with patients, and subsequent visualization of this data via population-level and patient-level views of symptoms and behavior patterns.

Further, aspects of the exemplary system and method herein supports patient self-management through an ability to self-report symptoms and issues, either through individual reports or self-established schedules. The patient may also review detailed self-generated health records. In consequence of accurate patient reports generated by the exemplary system, the HCP is able to better assess treatment compliance and efficacy, and provide more efficient care to patients.

Message-Driven Patient Engagement

The exemplary system herein includes clinically-relevant notification messages that are sent by the HCP through a server engagement engine to the patient's device. In an exemplary implementation, there are four main types of notification messages sent from a server to a remote device of a patient or a user related to the patient. Such notification messages include, in a non-limiting manner, queries about the patient's state or behavior; reminders about events or tasks; notifications about the availability of new information, such as educational material or visit plans; and requests that the patient participate in an interactive exercise using the device, the results of which are communicated to the HCP. Non-limiting examples of the interactive exercises include building body awareness, breathing for stress reduction, and other plan related activities that contribute to improving the lifestyle of the patient between visits.

Throughout this disclosure, unless stated otherwise, the server is also referred to as a first processed-based device. Similarly, unless indicated otherwise, the remote device is referred to herein as a second processor-based device. Moreover, the server or a first processor-based device is each, a computer or a collection of computers, where the collection of computers function as a unified server with data interconnections in the collection. For example, the unified server may be an application server for performing the software tasks disclosed herein and connected to a notification server for transmitting the notification messages. Furthermore, the unified server may include a user interface or host interface server for providing web pages or web applications for receiving HCP input or patient input. Still further, the unified server includes a database server or databases connected to the application server. The second processor-based device may be one of a smartphone, a computer, a tablet computer, a wearable computer, and a netbook. Other processor-based devices may be adapted to function in the exemplary system and method disclosed herein. Installation of a corresponding patient-side application to interact with the server, e.g., a mobile app for an Android®, iPhone®, Windows® Phone, BlackBerry®, or other related smartphones is one example of adapting the processor-based device to function as a second processor-based device.

In an example, the notification messages and the responses messages are relayed by technology that is available to the patient. SMS messages, multimedia messaging services (MMS), smartphone applications, or web-browser interfaces are examples of technology that are available to a person of ordinary skill to implement the exemplary system and method disclosed here. A multi-media component of the response message includes images or videos of the patient or a part of the patient that illustrates a medical condition. Additionally, images, videos, or UPC codes may be provided via the multi-media component illustrating food or other substances ingested, topically applied, or otherwise utilized by the patient.

All notification messages sent from the server to the remote device prompt a response from the patient, ranging in complexity from a simple acknowledgment of receipt of the notification message, to engagement in an interactive software component that generates multiple related responses. The multiple related response messages may include a response to a sequence of multiple-choice options in the notification message, for instance. The interactive software component allow reporting of clinically-relevant details similar to those that occur during in-person structured interviews conducted by HCP during office visits, but with just a few clicks.

In an exemplary implementation, patients are also able to engage with the system (and the HCP) on their own initiative. In one example, a report occurrence of unexpected symptoms, independent of having received a notification message may be initiated as a response message to the server using the remote device. Though the patient may use the exemplary system herein to initiate a response, all reporting using a response message is formatted to include the same or similar response parameters and interactive software components as the notification message-driven engagement, which is initiated by the server.

Engagement Protocols and Engagement Plans

In an aspect, the system disclosed herein allows HCPs to create and reuse notification message schedules which are software embedded messages configured for interacting with patients. Throughout this disclosure unless stated otherwise, the scheduled notification messages for a particular patient is referred to as an engagement plan or plainly, a plan. The notification message schedules may be initially coded as a template that is reusable with different patients. Throughout this disclosure unless stated otherwise, the notification message schedules coded as the template is referred to as an engagement protocol. When an engagement protocol is instantiated and/or personalized for use with a patient, the resulting plan is primarily applicable to that patient.

Personalization of an engagement protocol may occur in several forms. For example, a personalization to a response message format may be implemented via a personalization of the notification message. In one example, the multiple-choice options provided in the notification message can be limited to match the patient's range of current symptoms. Thereafter, it is understood that the response message generated corresponding to the notification message will include a selection by the patient of one or more of the multiple-choice options. In an example, this personalization allows the administrator of the engagement plan to limit the number of response options, thereby facilitating rapid responses from the remote device.

In an example, the query in the notification message may be modified using an engagement plan authoring software tool as part of the personalization offered to the engagement protocol. For example, the language in the query may be modified to better match the patient's reporting style. For example, during office visits the patient may choose to not use the word “nauseated” to describe a feeling, but will report feeling “queasy.” In an operation, using the engagement plan authoring software tool, the word “nauseated” in the engagement protocol template may be replaced by “queasy” in all notification messages related to nausea symptoms for the patient.

In an aspect of this disclosure, standard notification messages exist in software libraries for the engagement protocols that are template-drive. These standard notification messages may be organized by different searchable criteria. For example, criteria available for the standard notification messages include, without limitation, diagnosis, symptom type, compliance issues, and tasks. When preparing plans for a patient, the libraries may be searched and the pertinent notification messages found, and then included in protocols or engagement plans for the patient.

Furthermore, in an exemplary implementation, a combination of engagement protocols, notification messages, and scheduling for the notification message may be defined and saved as a new instantiable engagement protocol, which is still a template applicable for any patient. This allows an HCP to quickly develop patient specific engagement plans from an engagement protocol, and to also develop, save, and reuse an engagement plan as an engagement protocol, thereby creating a personal library of effective engagement protocols for use with patients.

In a further example, when using engagement plans, notification messages are transmitted at times determined by selection of scheduling options. Examples of the scheduling options include, without limitation, contextual scheduling; event-related scheduling, triggered by calendar events at specific times of day; or randomized scheduling, within proscribed limits. Contextual scheduling drives patient notifications based on the contextual properties associated with the location of the patient. Examples of contextual scheduling include, without limitations, weather related scheduling and scheduling based on air quality measures such as elevated pollen count or pollution levels. Contextual information may be obtained from a weather station or other source and may be important, as the context it represents may have a negative impact on the medical condition of the patient. To maximize patient engagement and increase the useful precision of notification messages, the exemplary system herein provides software tools, such as the engagement plan authoring software tool and an automated version of the engagement plan authoring software tool. The automated version of the engagement plan authoring software tool, from which engagement protocols can be automatically modified, is automated by software rules. The automation is possible by making the software tool responsive to the response message history, current environment, reported or inferred affective states, traits, and other factors corresponding to the patient from who the response message is received. In an example, the affective state and traits pertain to the reported or inferred psychological condition of a patient. In another example, adaptive engagement protocols allow the exemplary system to adapt to the patient's current desire for engagement with the HCPs. This is reflected in the patient's existing level of response performance, which is indicative of supporting increased patient engagement.

In a further example, a patient may, at any time, spontaneously engage with the system for state, symptom, or behavior reporting. This is represented by a response message initiated by the patient via the remote device. The response message may be sent after the patient has registered for using the exemplary system disclosed herein. Accordingly, the patient-initiated response message is essentially in response to the registration by the patient for using the exemplary system. In an example, after the patient has provided a response message relating to a request to participate in interactive exercises, follow-up notification messages may provide more information pertaining to the request. For example, an interactive exercise of breathing for stress reduction may be provided as a follow-up notification message to the remote device from the server. Further, the patient may be provided with single or multiple-choice options to add any of current engagements to the existing engagement plan, and subsequently to a customized engagement protocol, on a schedule of patient's choosing. The patient may also choose at any point to return to the “default” engagement protocol from which the plan was created, and that was defined by the HCP.

Data Analysis and Decision Making

The exemplary system and method disclosed herein supports several types of data analysis, as well as shared decision making for patients and HCPs. Non-limiting examples include automated analysis of response fidelity based on the response message timings; automated analysis of a response data component of the response message; and support for recording treatment decisions and tracking progress for meeting goals. In an exemplary implementation, the informational quality of patient responses affects the ability of the system to positively impact patient care. For example, a patient who has not responded sufficiently to the notification message may negatively impact the plan and consequently the exemplary system and method disclosed herein. A further negative impact is a result of incorrect or improper responses provided to notification messages. For example, an unrelated response, a delayed response, or a failure to respond are examples of negative impacts to the results sought for patient parameters of the engagement plan in effect. Patient parameters may include symptoms, treatment adherence, and performance, received after patient engagement and based on the patients input to requested queries.

To identify variation in behavior and to determine the fidelity of a response, a pattern-recognition software is implemented at the server to analyze status of the response messages (or lack thereof). The status may include one or more of: a receipt time corresponding to time of receipt of the response message at the first processor-based device; a first difference of time between the transmission of the notification message and the receipt of the response message; a second difference of time between the transmission of the notification message and the optional one or more follow-up notification messages; a third difference of time between the transmission of the notification message and the lack of the response message; and the administering time corresponding to the time of transmission of the notification message. Administering time also corresponds to a time when an element in the engagement plan is ready to be administered to the patient. In an example, multiple administering times may exist for each element of the engagement plan. That allows customizing of an engagement protocol so that a patient with multiple medical conditions may have an engagement plan with different elements, where each element corresponds to one of the medical conditions.

In an example, one or both of the status and each follow-up status are processed using the pattern recognition software on the first processor-based device. A pattern of responses is generated by the pattern recognition software and in accordance with one or more of the receipt time, the first difference of time, the second difference of time, the third difference of time, and the administering time. Further, the pattern of responses is optionally generated in accordance with one or more of the follow-up receipt time, the first difference of follow-up time, the second difference of follow-up time, the third difference of follow-up time, and the follow-up administering time. Further examples of times at which patterns may be processed include, in a non-limiting manner, a time the notification message was transmitted; a time the notification message was received by the patients device; a time the notification message was acknowledged in some way by the patient (e.g., clicked on to answer the interaction or dismissed by the patient); and a time at which a response message to the notification message was received.

Given these exemplary times, different patterns could be detected based on differences in the times. An example of a pattern recognition and implication may be is when the exemplary system herein determines the time between acknowledgement (e.g., clicking the notification message to engage with the system) and response by the patient (e.g., answering the question/request posed in the notification message). The time pattern is then analyzed. When the analyzed time is determined as being extremely short, there may be an automated implication that the answer is less trustworthy as the patient may not have taken sufficient time to think about the question posed. When the patient has a pattern of less trustworthy answers, their data will be flagged as suspect, and the HCP may discuss the use of the system with the patient to improve patient engagement.

The analysis of the status and the response message determines the patient parameters, which in turn corresponds to the performance of the administered plans. When the patterns are inconsistent and therefore, the response data of the response message are suspect, a follow-up notification message may be sent by the server to verify the response message. An incorrect response message may be obtained by deliberately randomizing the order of the response choices in the multiple-choice queries to ensure that the user is not answering the queries by rote (e.g., always choosing the first option in a list of possible answers). Accordingly, the pattern recognition of the status and the response message provide the patient parameters of the exemplary system and method disclosed here. Furthermore, the pattern of responses determines either a retention or a change in the administering time and each of the follow-up administering times.

In another example, the pattern of responses determines a time compliance patient parameter that corresponds to a determination that the patient is in compliance with the administered engagement plan. In yet another aspect, the pattern recognition software includes one or more of a classification software, a correlation software, and a clustering software. The pattern recognition software may be a discriminant analysis software, a decision tree software, Bayesian test software, or a k-means clustering software.

In an example, the pattern-recognition process is an automated quality analysis that checks for at least stereotypy and internal consistency of the response data component of the response message. Stereotypy, as used herein, unless indicated otherwise relates to a situation, where a patient or user of the exemplary system and methods herein provides stereotypical answers to a query posed. For example, the patient or user may always select the first option in the multiple choice responses to the query. Further automated quality analysis is performed using a meta-data component of the response message. The meta-data component includes information about the response message such as, a speed of response in milliseconds (ms), which may be calculated from the time of arrival of the notification message to the time of transmission of the response message from the second processor-based device. In an example, the speed of response is typically as low as between 400 ms to 900 ms. Furthermore, the meta-data component includes a time of transfer of the response message, among other information related the processor-based device. In an example, the status is derived from the meta-data or may be independent of the meta-data. Response fidelity issues may drive the automatic modification of engagement protocols, and may be flagged for HCP intervention. For example, the order of multiple-choice query options in a follow-up notification message can be randomized over time to test for and overcome stereotypy.

In a further example, the response message performance patterns are automatically monitored using the pattern recognition software to drive adaptive modification of the engagement protocols. Response performance include analysis of the frequency of response based on the time of response for each response and each follow-up response, latency of response based on the time of transmission of the notification message (or each follow-up notification message) to the time of receipt of a response message (or each follow-up response message); and completion of an interactive routines that is determined by a set series and sequence of notification message, a corresponding response message, each follow-up notification messages, and each corresponding follow-up response messages. Each of these messages may be monitored to identify effects of the engagement protocol, including the patient parameters, such as message frequency, time of day or day of week of the response message and each follow-up response message, and the response data component of each response message and each follow-up response message. The response fidelity is also a validity patient parameter that is used to determine the performance of the administered engagement plan. Poor performance on the validity patient parameter is indicative of failure of the patient to adhere to the administered engagement plan, or a failure of the patient to understand how to use the exemplary system properly. This situation prompts inquiry by HPC to disambiguate these possibilities.

In an exemplary implementation, the response to the multiple-choice queries itself forms a pattern. For example, a choice of specific symptoms for report can alter the response options offered in a follow-up notification message. When an option is never selected, it can be eliminated or replaced with another one in the follow-up notification message. Further, when a response performance to a given engagement protocol or engagement plan is good, a higher level of engagement may be initiated to allow collection of more symptom reporting, or to support a deeper level of behavioral change. When the response data component is automatically monitored, problem areas such as compliance issues and symptom flare-ups can be flagged for HCP attention. This allows HCPs to have insights into patient challenges as they are identified, potentially avoiding complications. The information available in response data component can be used to make shared decisions about the course of treatment, and can also bring about an automated modification of the template engagement protocol, so as to focus on a particular issue more effectively.

In an exemplary implementation, the optional one or more follow-up notification messages correspond to one or more of the response data component and the status of the response message from the meta-data component. In another example, the notification message and the optional one or more follow-up notification messages includes one or more of a query, a reminder, a notification, and a request. In the event that the notification message includes a query, the query may include one or more parts. One part may include a request for acknowledgment of the notification message, where the acknowledgement, when acquired, provides at least a part of the response data component. Another part may include a multiple choices user-selection, where a selection from the multiple choices provides at least a part of the response data component. Yet another part may include a modifier to the multiple choices user-selection, where a modification of the multiple choices provides at least a part of the response data component. Further, the multiple choices user-selection and the modifier may correspond to a state of the patient. The modifier may also include an input provided by the patient or a user related to the patient.

In an exemplary implementation, the reminder type of notification message includes one or more of a reminder to acknowledge the notification message, where the acknowledgement, when acquired, provides at least a part of the response data component; or a request for a best time to send a future notification message or the optional one or more follow-up notification message. When the best time is acquired from the patient or a user related to the patient, it is in turn provided as at least a part of the response data component.

Furthermore, in another aspect, the notification message includes a new information notification providing information of education materials or visit plans for the patient. A further request for the new information may form at least a part of the response data component. In yet another aspect, the request type of notification message includes a request for the patient to participate in activities prescribed in the administered engagement plan.

In an exemplary implementation, the first processor-based device is also configured for receiving one or more follow-up response messages in response to the optional one or more follow-up notification messages. Further, the engagement software application executing on the first processor-based device is configured for receiving a follow-up status corresponding to each of the optional one or more follow-up notification messages and each of the one or more follow-up response messages. The engagement software application is also configured to determine follow-up patient parameters in accordance with the one or more follow-up response messages and each follow-up status. The follow-up patient parameters may then amend the patient parameters previously determined.

In a further aspect the follow-up status may include one or more of different time components. In one example of a time component, the follow-up status includes a receipt time corresponding to time of receipt of each follow-up response message at the first processor-based device. In another example, the follow-up status includes a difference of time between the transmission of each optional follow-up notification message and the receipt of each corresponding follow-up response message. In yet another example, the follow-up status includes a difference of time between the transmission of each optional follow-up notification message and any subsequent follow-up notification message. Another follow-up status may include the difference of time between the transmission of each optional follow-up notification message and the lack of the corresponding follow-up response message. Another time component in the follow-up status may be a follow-up administering time corresponding to the time of transmission of each optional follow-up notification message.

### EXAMPLE

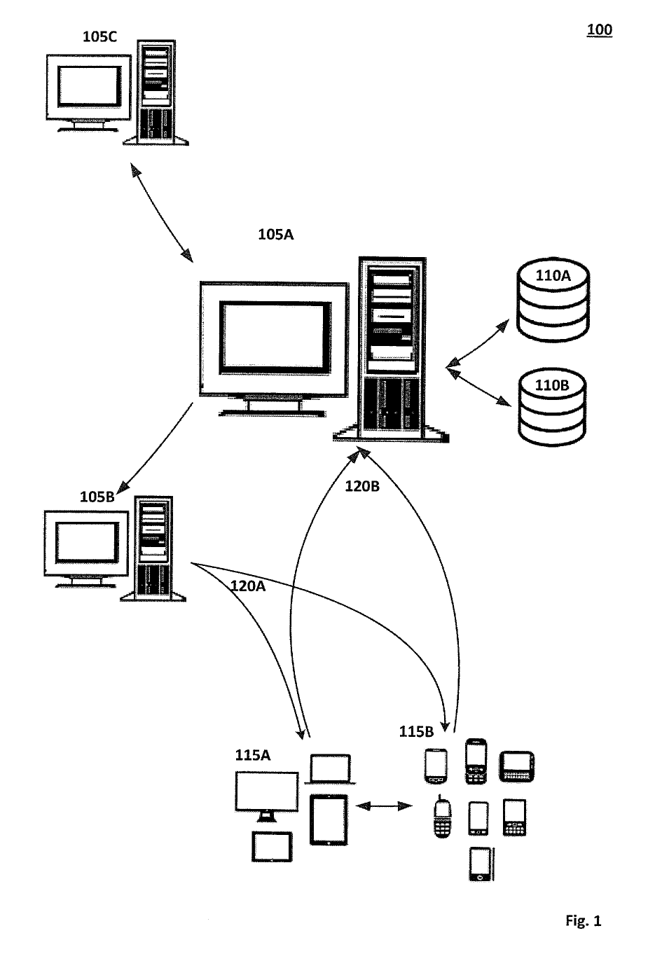

FIG. 1 illustrates a processor-implemented system 100 for eliciting patient engagement corresponding to an engagement plan administered to the patient. The processor-implemented system 100 includes first processor-based device 105 for determining an engagement protocol for the engagement plan corresponding to the patient.

The server 105 may be a unified server with specification servers 105A-C offering specific functions. Server 105C may be a computer available to the HCP or patients, and including a patient and provider profile creation software tool, for allowing patients and HCPs to create personalize profiles within the system. The patient and provider profile creation software tool forms part of a builder software application, which is used for creating engagement plans from engagement protocols and also for building engagement protocols. The engagement plans are customized for the patient from engagement protocols, each generally targeting medical conditions and stored in a database. Alternatively, patients may use a smartphone, tablet, or computer 115, each executing a corresponding web-based software application that interfaces with the builder software application to create the profile. Further, the plan authoring software tool allows HCPs to create reusable notification messages, engagement protocols, and engagement plans, and save them to a library, and use them in other contexts. Reference to server 105 is understood to include one or more of servers 105A-C. Server 105 includes an engagement software application for supporting the activation of individual patient engagement plans, recording to response responses, and engagement of a scale of a patient population. Furthermore, the patient-facing mobile technology, illustrated as any of devices 115, each including a corresponding stand-alone native application or web-based application that allows patients to receive and respond to notification messages wherever they may be.

The engagement plan is stored in a database 110 related to the first processor-based device 105 and the engagement protocol is selected for the patient concerned. An engagement software application on the first processor-based device 105 is configured for monitoring the engagement plan relating to the patient to determine that an administering time for administering the engagement plan has been reached. The engagement software application on the first processor-based device, e.g., server 105A, is further configured for generating a notification message for a notification server queue 105B when it is determined that the administering time has been reached. Further, the notification message corresponds to the engagement protocol of the engagement plan. In an example, a node.js script with an argon push notification module is implemented to code the module within the engagement software application for messaging. Furthermore, in another example, JavaScript is used for coding the engagement software application. The engagement protocols may be represented via software code. For example, JSON script may be used for the engagement protocols. The processor-based device 105 is a hardware device with integrated operating system to perform the functions disclosed herein. In one example, UNIX, Mac OS X, and/or Linux are exemplary operating systems for the processor-based device 105.

The notification server queue 105B is configured for transmitting 120A the notification message to a registered second processor-based device 115. The transmission 120A may proceed via any transmission media, including, but not limited to, Wi-Fi™, wired, or regular mobile voice or data communication. The notification message includes an interactive software component for receiving a response message from the second processor-based device 115. The response message or a lack of the response message optionally initiates one or more follow-up notification messages to be sent to the second processor-based device 115. The engagement software application on the first processor-based device 105 is also configured to receive, via communication paths 120B, the response message and a status corresponding to the notification message and the response message. Further, the engagement software application is configured to determine patient parameters in accordance with the response message and the status. The patient parameters can be used to assess the performance of the administered engagement plan.

In a further exemplary implementation, server-side patient data repository and analysis software tools may reside on the server 105A for storing of patient data, response messages, and statuses in databases 110A-B and for analyzing the patient data to determine the patient parameters, including a validity patient parameter, quantified by a response quality and a response performance. Analysis of the response data component provides a compliance patient parameter. Each of the validity and the compliance patient parameters determine the patient parameter representing the overall performance of the administered engagement plan. Furthermore, the validity patient parameter may include a time compliance patient parameter to verify that the administering time and the receipt time are appropriate.

In an exemplary aspect, the first processor-based device 105 is configured for analyzing the status to determine a validity patient parameter corresponding to the validity of the response message prior to determining the patient parameters. Further, the status optionally may include a meta-data component of the notification message and the response message or from the first processor-based device, which is also configured for monitoring the notification message and the response message. In another exemplary aspect, the first processor-based device 105 is configured for analyzing a response data component of the response message to determine a compliance patient parameter to determine that the patient is in compliance with the administered engagement plan.

In yet another aspect of this disclosure, the first processor-based system is configured for receiving a selection for the engagement protocol on a web-based application executing on a third processor-based device, e.g., 105C or the first processor-based device 105A. The selection protocol is received from one or more engagement protocols stored in the database 110. Furthermore, the selected engagement protocol corresponds to the engagement plan for the patient and is provided as the engagement protocol determined by the first processor-based device. In one example, the one or more engagement protocols correspond to one or more different health conditions. Alternatively, the one or more engagement protocols correspond to one or more previously administered engagement plans.

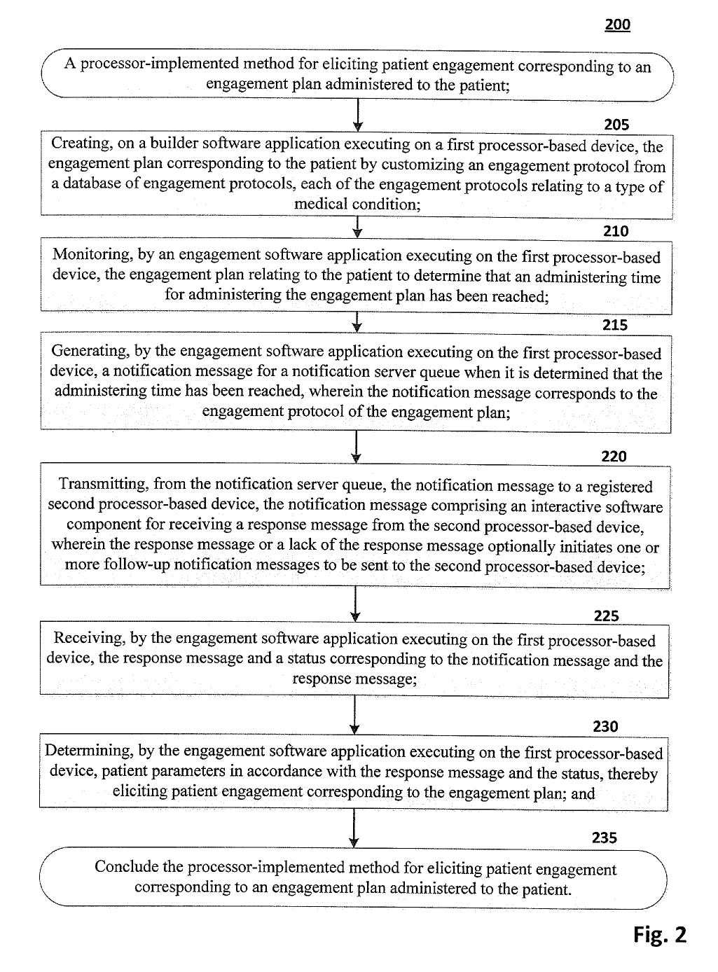

In an aspect of the disclosure herein, FIG. 2 illustrates a processor-based method 200 performed via the hardware in FIG. 1 for eliciting patient engagement corresponding to an engagement plan administered to the patient. The processor-based method includes a creating function, by a first processor-based device and as illustrated by block 205, for creating the engagement plan corresponding to the patient. The engagement plan is created by customizing an engagement protocol from a database of engagement protocols. Each of the engagement protocols typically relate to a type of medical condition. The engagement plan is stored in a database related to the first processor-based device and the engagement protocol being is selected for the patient. A monitoring function is illustrated by block 210 and performed by an engagement software application on the first processor-based device. The monitoring function performs monitoring of the engagement plan relating to the patient to determine that an administering time for administering the engagement plan has been reached. When it is determined that the administering time has been reached, a generating function illustrated in block 215, by the engagement software application on the first processor-based device, provides a notification message for a notification server queue. The notification message corresponds to the engagement protocol of the engagement plan. A transmitting function of block 220, from the notification server queue, transmits the notification message to a registered second processor-based device. The notification message includes an interactive software component for receiving a response message from the second processor-based device.

Further, the response message or a lack of the response message optionally initiates one or more follow-up notification messages to be sent to the second processor-based device. A receiving function in block 225, by the engagement software application on the first processor-based device, receives the response message and a status corresponding to the notification message and the response message. A determining function of block 230, by the engagement software application on the first processor-based device, determines patient parameters in accordance with the response message and the status, where the patient parameters provides the performance of the administered engagement plan. Block 235 concludes the processor-based method 200 for eliciting patient engagement corresponding to the engagement plan administered to the patient.

### EXAMPLE

### Generating Engagement Plans

Exemplary system 100 includes multiple hardware components 105-110 and related software components, as described by the functional blocks 200-235 of the flowchart in FIG. 2, to provide engagement protocols for a patient. These software components may be software applications and may include scripts and computer codes related to data and interactive components, including messages, modules, plans, and protocols. The generation of engagement plans corresponds to the determining function in block 205, where the method and systems herein, in part, are used to determine engagement protocols for engagement plans corresponding to the patient. In this disclosure, patients are engaged using scheduled notification messages delivered from the processor-based devices 105 functioning as a unified server or server components, to the second processor-based device 115 in accordance with an engagement plan. The notification messages are composed of two parts: a message body, including a query, reminder, notification, or request, where the message body is a notification data component, and response options forming the interactive software component as described in block 220 of FIG. 2. For simplicity, notification messages are used herein to include follow-up notification messages, unless indicated otherwise. Similarly, response messages are used herein to include follow-up response message, unless indicated otherwise.

As described with respect to the engagement software application, in an example, a node.js script with an argon push notification module is implemented to code the software components, including messages and modules disclosed herein. Furthermore, in one example, JavaScript is used for coding the software applications and in another example, UNIX, Mac OS X, and/or Linux are exemplary operating systems for the processor-based devices herein.

Notification messages associated with specific health/medical conditions are grouped into modules for easy access during plan development. Databases 110 may form the storage devices for these modules representing the engagement protocols available to the HCP. Notification messages that are relevant to a patient are selected from modules, and scheduling information is added to create an engagement plan. Plans may also be saved as protocols, which can be tailored to patients from the protocols, but may be reused for other patients.

### EXAMPLE

### Generating Engagement Plans—Notification Message Aspect

In this example, notification messages include questions regarding a patient's physical or emotional state, reminders of something important in the management of their condition, or activities to help the patient gain new skills. Notification messages may further be simple or complex. Simple messages take the form of a single question, reminder, notification, or request, requiring a single response message. A complex notification message is a sequence of simple notification messages (including the follow-up notification messages) and a corresponding sequence of response messages (including the follow-up response messages). The content and order of the sequence may be determined by the response messages, including the follow-up response message, each provided for a prior notification message sent earlier in the sequence.

Further, simple notification messages are created using a message builder, which allows the individual constructing the notification message to provide a title, the notification message data—question or statement, and options for populating the response message. The response message can include a simple acknowledgement of receipt of the notification message, or can be one or more of the set of options provided for response.

In an aspect, complex messages are created through notification message and corresponding response message chaining, which then includes follow-up notification and response messages. This involves connecting the response to a prior notification message to a follow-up notification message, each interjected with the corresponding response message or follow-up response message. The follow-on notification message may pass context information, which can be data based on any or all of the prior response messages and follow-up response message received to the point of the follow-up notification message seen thus far. This context information can be used to automatically tailor the follow-up notification message through parameterization.

In this example, a notification message builder software application can support easy creation of complex notification messages as well as simple notification messages. The notification message builder software application is part of the builder software application and is a special tool that allows users to create and manage trees of notification messages. The trees may include illustrative branches corresponding to the response messages received for each prior notification message. As a user moves from the root of the tree representing the first notification message, to subsequent follow-up notification messages represented by nodes on the tree, a response message is passed along the way. The response messages may include follow-up response messages including all responses to the initial notification messages that were encountered within the complex notification message. The notification message builder software application supports easy access to this context store database 110 in system 100 for populating the notification data component corresponding to the notification message within the tree.

### EXAMPLE

### Generating Engagement Plans—Module Aspect

In this example, modules are part of the engagement protocol or an engagement plan, and are generated to address the complex informational support, e.g., specific diseases, which require specialized care. A module builder software application, forming part of the builder software application previously disclosed, may be executed on the server computer 105 for populating notification messages relating to a particular disease condition. The grouped notification messages are referred to as modules, and typically reflect the complexity of the disease. Once created, modules are reusable across multiple patients, either wholly or partially. Partial reuse of the modules is implemented by the builder software application, by selecting various notification messages and grouping them to form a new group. In a further example, a module is created based on the expert knowledge corresponding to a specific health/medical condition to be addressed. The condition aspects to be addressed are identified and select notification messages are chosen based on the expertise available for the specific health/medical condition. Then the notification messages are combined into a module corresponding to the specific health/medical condition.

Further, in this example, to use the module created above, the HCP uses a browser-based authoring tool that interfaces with the module builder software application forming part of the builder software application. The browser-based authoring tool is used to create a profile for a patient that includes the patient's relevant medical issues. These medical issues typically include those that are currently addressed by current treatment administered by the HCP. The profile may be created through interaction with the browser-based authoring tool or by automatically obtaining relevant information from another clinical system that is compatible with the browser-based authoring tool. In one example, a compatible system may be a form that is coded in HTML and that is provided by a doctor to the patient via a web-portal or web-page. The profile may also include information about the devices the patient may use to interact with the system. Based on the profile, modules that are applicable to the patient automatically appear in the portal or web-page. These modules are then used as whole, or select notification messages within them are extracted. The browser-based authoring tool also allows for searches for other notification messages that may are then joined into the engagement plan of this example.

Also, in this example, a plan builder software application of the builder software application uses a set of applicable modules, with specific notification messages to form an engagement plan. The modules and the messages within them are then included within the plan. Because there is a limit to the number of interactions that a patient can support in their daily life, the software applications herein allow for selection of the number of messages to deliver to allow for meaningful engagement to take place. The system 100 has provisions for warning external users that an engagement burden of an engagement plan is high. This plan builder software application allows for schedule information to be developed corresponding to each message. Scheduling provides a rich vocabulary for setting dates and times on the notification messages, as well as scheduling based on contextual conditions. For example, anything related to external, internal, or system usage information for system 100. In a further example, a given date and time can be specified, e.g., May 12, 2014 at 2:30 PM, for sending the notification messages.

In another aspect, date and time patterns, e.g. “every Tuesday” at “4:00 PM” is an acceptable schedule for a notification message. Further, contextual scheduling is applicable in the systems and methods disclosed herein, where in specific medical/health plans, the notification messages are condition specific rather than general. In one example, an asthmatic patient is provided with notification messages relating to monitoring their symptoms when an elevated pollen count, pollution index, or adverse weather pattern are detected based on daily information from a weather service. Contextual measures, such as pollen count, pollution index, or weather patterns, can trigger messages for people with medical conditions that are affected by the context associated with these measures. Contextual, as well as date and time scheduling may be combined to yield very detailed approaches scheduling messages.

### EXAMPLE

### Generating Engagement Plans—Engagement Protocol Aspect

The system and method disclosed herein provides flexibility relating to reuse of information for an engagement plan. The reuse of information is useful to support standards of care. As previously disclosed, an engagement protocol is an engagement plan that has been created for reuse across a patient population, rather than for specific patient. Engagement protocols are available in a library stored in databases 110. The library is easily accessible and is easily modified for use with a patient. For example, when it is decided that one or more patients need determination of an engagement protocol or an engagement plan (depending on the patient group size) corresponding to a newly diagnosed condition, the software applications and the server systems herein allows for customizing of one or more engagement protocols to determine an engagement plan or a customized version of the engagement protocol. A newly diagnosed medical condition may be celiac disease, for which engagement protocols are developed, and from which, a further engagement plan may be determined. When a patient in the patient group arrives at a facility, the customized engagement protocol may function as the plan for engaging the patient. Alternatively, the determined engagement plan is applicable for the same purpose.

### EXAMPLE

### Executing Engagement Plans

In this example, as illustrated by blocks 210-225, once an engagement plan has been created and associated with a patient, the engagement software application executing on the server 105A, along with the notification server queue represented by server 105B, provides the monitoring, generating, and transmitting aspects of FIG. 2. In one exemplary implementation, a queue preparation step involves the monitoring step to determine that a time for deploying notification messages has been reached. Then, for example, at midnight of each day, notification messages are generated and the notification server queue is populated with all the notification messages that are applicable for that day for all patients who have active engagement plans. This daily generation includes determining when notification messages should be delivered. Further, the notification messages may be randomized, with specific randomization within the messages. In one example, the response option order may be randomized. The randomization process is a verification tool for testing fidelity of a response message, to determine that the response is a coherent response.

In one example, with respect to the transmitting function of block 220, the notification messages in the notification server queue are time-stamped to indicate when the notification message is supposed to be delivered to the patient. The time stamp forms a meta-data component of the notification message. The engagement software application selects the messages from the queue that are applicable for delivery, and transmits them to the second processor-based device 115, corresponding to a patient or a user related to the patient. The selecting and transmitting of messages may progress via triggering functions. For example, polling methods, at regular intervals, of for e.g., a minute may apply to determine messages for transmission and to initiate transmission. In another example, interrupt-driven or event-based triggers are also applicable. This example herein is described with reference to a single patient, but the system and method may be replicated to multiple patients. The patient's profile contains registered information of the second processor-based devices and corresponding device channels that will be used for delivering the notification messages. The device channel selected also determines the system location for the engagement software application, enabling the engagement software application to perform the function of block 225 for receiving the response messages. This is performed using a listening process, where the engagement software application listens for a response to the notification message, and a non-blocking event handler is put in place on this location to wait for each response message corresponding to the one or more patient response.

With respect to block 230 of FIG. 2, in this example, when a response message is received at the first processor-based device, the response message is an answer to the earlier notification message. The response message is generated when a selection is provided on the interactive software component of the notification message. The selection forms the response data component of the response message. The selection is bundled into a time-stamped response message, forming the meta-data component of the response message. The response message is then sent to the engagement software application, to the handler listening for the response message.

### EXAMPLE

### Patient Initiated Engagement

In an alternative implementation, the system and methods herein allow for a second processor-based device to engage the first processor-based device. Such a response message may be an initiative to report occurrence of symptoms, for example. This is independent of receiving a notification message. This may be implemented through activation of a menu system on the second processor-based device that provides a broad selection of reporting options and exercises for the patient's health conditions. In an example, the activation of the menu system functions as a notification message to the second processor-based device. The unsolicited patient report from the second processor-based device may be a response message to the activation by the user of the second processor-based device. The patient-initiated engagements are also logged to the server for review by the concerned specialists. Though the patient is free to use the system in this manner, all such engagement uses the same response parameters and interactive routines as the message driven example disclosed here.

Accordingly, the patient-initiated response messages also clinically-relevant. To facilitate patient-initiated engagement, a selection may be made on the engagement software application or the builder software application indicating that a time for administering the engagement plan is an open-ended time parameter. This allows the engagement software application to review options relevant to the patient's condition, which are then available for the patient to use spontaneously, without a notification message prompt. These may be made part of the patient's profile via the determining step of block 205. Further provision of options or restrictions may be provided by the monitoring or determine blocks 205-210, via the servers, so as to not overwhelm patients with too many response options in a notification message.

### EXAMPLE

### Patient Parameters

In the example herein, analysis of the data supports one or more of three different purposes. One purpose is to provide an understanding as to the quality of information provided by the patient. Another purpose is to discover what the data actually reveals about the patient's status and engagement with respect to their condition. A third purpose is to provide help with the engagement, where the system automatically adapts the engagement plan to changing circumstances and the patient's engagement style.

Verification of the informational quality of patient response messages is important in a processor-based system, where the patient engagement processes are automated. There are many ways in which a patient could provide a response message that may prove meaningful. Some exemplary quality indicators include speed of response, response stereotypy, and internal consistency of the response messages. Speed of response is measure corresponding to detecting when patients may not be attending to the content of the notification message making it likely that their response messages are improper response choices that were only selected for purposes of verification. The speed of selection may not fully reflect the reality of the patient's situation, so a further check is made for the frequency of selection of the same ranked response. For example, if the patient selects the first response to a multiple-choice query too often, this along with the speed of selection may be an indicator of a suspect response. To detect the speed of response, a measure of the time of transmission of a message or the time of viewing of a message is registered.

For purposes of simplicity, the time of viewing is used interchangeably with the transmission time, unless indicated otherwise. There may be delays in the transmission time and the receipt by the receiving second processor-based device. One of ordinary skill would understand that a modification of the software application may counter such delays by adding a time-stamp that accounts for the delay. Then a response time, corresponding to when a response is logged is also registered. Alternatively, the response time is when the response message is sent from the second processor-based device and not when it was received at the first processor-based device. For simplicity, the disclosure herein uses the same response time to indicate either of the two possibilities. One of ordinary skill would understand that a modification of the software application may choose to incorporate either a time-stamp when transmission starts for the response message or when the response message is received. When the time between transmission of a notification message (or time of viewing of a notification message) and time of receipt of a response message is so short that it is evident that the patient could not have read or responded properly, the response message is marked as suspect. A follow-up notification message may issue as a result to verify the response message. The analysis of the time related constraints from the notification messages and the response messages provide the time compliance patient parameters. Further, an analysis of the follow-up time related information for the follow-up notification and response messages provide the follow-up patient parameters that amend the time compliance patient parameters previously determined.

Response stereotypy involves a response message (and follow-up response message) pattern that is independent of options content in the notification message. For example, selection of only the first option as a response message to different notification message is a form of response stereotypy. The system and method herein include software application to detects stereotypy by randomizing the order of important items as they are presented over time, including message ordering, response options, etc. Stereotypy is typically detectable across multiple responses, so once enough data is provided, the system and method herein will do correlation analysis to identify periods of suspect stereotyped responses.

In a further example, testing for internal consistency is processed for the response messages as well. This involves detecting contradictory responses across a set of response messages that belong together. Contradictory responses may indicate that the patient either did not understand the questions, or did not respond accurately. Providing software rules that describe which combination of responses are consistent and which are contradictory enables the detection of internal consistency. When a given set of response messages arrive, the system automatically reviews the response data component against the software rules to determine information that may be suspect. The results of these analyses will be presented in the system for each patient. The analysis of the stereotypy and internal consistency related constraints from the notification messages and the response messages provide the validity patient parameters. In each case of stereotypy or inconsistency, a follow-up notification message may issue as a result to verify the response message. Further, an analysis of the follow-up validity information from the follow-up notification and response messages provide the follow-up validity patient parameters that amend the validity patient parameters previously determined.

Analysis of patient status is based on the content of the engagement data, which is useful for two different purposes. In one purpose, the patient can use the insights from the data to better manage their own condition. In a second purpose, the data is used to provide insights corresponding to patient populations, and to providing better care, by the administrator of the system, for the patient. Patients can further review their response message history to discover patterns that affect their condition of which they may not be aware. For example, a patient with food sensitivities who does a period of detailed food and symptom tracking may become aware of their own symptom-inducing problem foods that they previously did not know about. The system assists patients in such awareness by automatically performing correlation analyses across reported information for pattern recognition. With regular use of the system and method disclosed here, a database of clinically-relevant information is developed, from which base assessments may be made. This also provides relevant data for changes related to self-management by a patient.

The data may also be reviewed by users of the system and method, on both individual patients and patient populations. For the individual patient, the system presents data that includes measures of symptom occurrence and severity, treatment compliance, behavior and behavioral change, and the level of patient engagement with the engagement plan. The analyses disclosed herein also provide a summary for the patient, presented as a timeline of all reported information from the response messages. Specific reports may also be requested from the system regarding specific symptoms, compliance issues, and other parameters. Selection and modification of indices of patient status may be performed, when there is a general understanding that the indices apply to entire patient populations. For example, a composite health score may be created using the exemplary system here, and which is based on numerical values assigned to symptoms, severity, compliance, and adverse events. This will allow rapid assessment of patient status and progress, and can be very useful in determining clinical cases that require more involvement for future engagement plans or other interventions. This is an increasingly useful approach that incorporates an outcome-based approach.

In further examples of the system and method herein, subpopulations can also be defined based on select parameters, including phase of treatment, time since diagnosis, comorbidities, and a compliance index (e.g., diet compliance). In other examples, response messages and the performance patterns are automatically monitored to drive adaptive modification of protocols. Response message patient parameters relating to time compliance and validity provide further input for modification of schedules and content for the notification messages. For example, frequency of response, latency of response, and completion of interactive routines may be monitored to identify effects of protocol on the time compliance patient parameters such as message frequency, time of day or day of week, and message content. In an example of response message patient parameter, patient non-responsiveness to a particular notification message type or delivery time can lead to automatic message simplification or schedule adjustment. In yet another example of response message patient parameter, response latency differences in messages sent at different times of day can drive the creation of a different message schedule. In yet another example, response choices, for example, choice of specific symptoms for a report can be altered to reflect response patterns. One example of a response pattern is when a response option is never selected, it can be eliminated or replaced with another one.

In still another example of response message patient parameter, good response patient parameters to a given protocol can lead to a higher level of engagement to allow for more symptom reporting, or to support a deeper level of behavioral change. Furthermore, response content is also automatically monitored so that problem areas such as compliance issues and symptom flare-ups may be flagged for further attention. This can also bring about an automated modification of protocol to focus on the issue.

After the patient is engaged in the system for a period of time, the patient will be able to review patient engagement data (PED) generated by the above patient parameters. The patient may review the PED prior to the next office visit, thereby identifying points of discussion and exploration. During the next office visit, the patient's treatment and the patient's engagement plan may be collaboratively modified to address health issues revealed by analysis of the PED. For example, messages about treatment compliance (e.g., avoidance of food allergens) may show that treatment compliance requires more support. The information about compliance problems from the compliance patient parameters also allows for changes that contribute to a more informed assessment about the efficacy of the current engagement plan. For example, a distinction may be made between lack of compliance with treatment and failure of treatment, because compliance problems can prevent a good test of treatment efficacy. The patient may also review and edit the wording of messages related to compliance issues to make them more effective. Further, the system may be used to change the schedule of the notification messages for future events for the patient.

Automated modifications may be made to the engagement protocol based on agreements with the patients and to reflect a change in symptom presentation. As an example, after 1 week, “cramping” was automatically eliminated as a response option from a GI symptom message in the patient engagement plan, and replaced with “diarrhea,” because patient did not ever report “cramping” but did make self-report symptoms of “diarrhea.” Thus, prompted by the PED, there is better focus of attention related to new problematic symptom and making adjustments to treatment to address these new symptoms. With regular use of the system, the patient may develop a database of clinically-relevant information on which to base assessments of, and to which changes are made for self-management purposes. Such changes to the system per the patient parameters may be requested individually or in conjunction with medical/health service provider and/or insurance providers. For example, a patient with food sensitivities may be motivated to provide detailed food tracking and symptom tracking, which can help identify workable diet choices.

In a further exemplary implementation, payers or organizations that pay for health care costs for individuals may use the PED to make more informed decisions. Payers may include insurance companies and governmental agencies such as Medicare, Medicaid, and the Veterans Administration (VA). Payers can offer protocol engagement capabilities to providers and patients in order to improve health outcomes based on a broader PED database retained from individual health institutions. Accordingly, the system and method here provides payers with data at many levels of detail. Some examples of the levels of detail include provision of data for quantifying and reporting provider/patient engagement; provision of data for deriving best practice information; provision of data for development of educational material based; provision of data for developed incentives for provider/patient engagement; provision of data for characterizing patient and/or provider populations; and provision of data for developing policies based on insights from patient/provider. Also, it is also possible to generate reports of patient engagement that the HCP may provide to their employers or payers.

The exemplary methods and acts described in the implementations presented previously are illustrative, and, in alternative implementations, certain acts can be performed in a different order, in parallel with one another, omitted entirely, and/or combined between different exemplary implementations, and/or certain additional acts can be performed without departing from the scope and spirit of the disclosure. Accordingly, such alternative implementations are included in the disclosures described herein.

The exemplary implementations can be used with computer hardware and software that perform the methods and processing functions described above. Exemplary computer hardware include smart phones, tablet computers, notebooks, notepad devices, personal computers, personal digital assistances, and any computing device with a processor and memory area. As will be appreciated by those having ordinary skill in that art, the systems, methods, and procedures described herein can be embodied in a programmable computer, computer executable software, or digital circuitry. The software can be stored on computer readable media. For example, “software tool,” “computer code,” “software application,” “software module,” “scripts,” and “computer software code” are software codes used interchangeably for the purposes of simplicity in this disclosure. Further, “memory product,” “memory,” “computer-readable code product” and storage can include such media as floppy disk, RAM, ROM, hard disk, removable media, flash memory, memory stick, optical media, magneto-optical media, CD-ROM, etc.

Although specific implementations have been described above in detail, the description is merely for purposes of illustration. It should be appreciated, therefore, that many aspects described above are not intended as required or essential elements unless explicitly stated otherwise. Various modifications of, and equivalent acts corresponding to, the disclosed aspects of the exemplary implementations, in addition to those described above, can be made by a person of ordinary skill in the art, having the benefit of the present disclosure, without departing from the spirit and scope of the disclosure defined in the following claims, the scope of which is to be accorded the broadest interpretation so as to encompass such modifications and equivalent structures.

We claim:

1. A processor-implemented method for eliciting patient engagement corresponding to an engagement plan administered to the patient, the processor-implemented method comprising:
creating, on a builder software application executing on a first processor-based device, the engagement plan corresponding to the patient by customizing an engagement protocol from a database of engagement protocols, each of the engagement protocols relating to a type of medical condition;
monitoring, by an engagement software application executing on the first processor-based device, the engagement plan relating to the patient to determine that an administering time for administering the engagement plan has been reached;
generating, by the engagement software application executing on the first processor-based device, a notification message for a notification server queue when it is determined that the administering time has been reached, wherein the notification message corresponds to the engagement protocol of the engagement plan;
transmitting, from the notification server queue, the notification message to a registered second processor-based device, the notification message comprising an interactive software component for receiving a response message from the second processor-based device, wherein the response message or a lack of the response message optionally initiates one or more follow-up notification messages to be sent to the second processor-based device;
receiving, by the engagement software application executing on the first processor-based device, the response message and a status corresponding to the notification message and the response message; and
determining, by the engagement software application executing on the first processor-based device, patient parameters in accordance with the response message and the status, thereby eliciting patient engagement corresponding to the engagement plan.

2. The processor-implemented method according to claim 1, further comprising:
analyzing, by the first processor-based device, the status to determine a validity patient parameter corresponding to the validity of the response message prior to determining the patient parameters.

3. The processor-implemented method according to claims 1 or 2, wherein the status is obtained from either:
a meta-data component of the notification message and the response message; or
the first processor-based device configured for monitoring the notification message and the response message.

4. The processor-implemented method according to claim 1, further comprising:
analyzing, by the first processor-based device, a response data component of the response message to determine a compliance patient parameter to determine that the patient is in compliance with the administered engagement plan.

5. The processor-implemented method according to claim 1, further comprising:
receiving, on a web-based application executing on a third processor-based device or the first processor-based device, a selection for the engagement protocol from one or more engagement protocols, the selected engagement protocol corresponding to the engagement plan and provided as the engagement protocol that is determined by the first processor-based device.

6. The processor-implemented method according to claim 5, wherein the one or more engagement protocols correspond to one or more different health conditions.

7. The processor-implemented method according to claim 5, wherein the one or more engagement protocols correspond to one or more previously administered engagement plans.

8. The processor-implemented method according to claim 1, wherein the optional one or more follow-up notification messages correspond to one or more of: the response data component and the status of the response message from the meta-data component.

9. The processor-implemented method according to claim 1, wherein the notification message and the optional one or more follow-up notification messages comprise one or more of: a query, a reminder, a notification, and a request.

10. The processor-implemented method according to claim 9, wherein the query comprises one or more of:
a request for acknowledgment of the notification message, wherein the acknowledgement, when acquired, provides at least a part of the response data component;
a multiple choices user-selection, wherein a selection from the multiple choices provides at least a part of the response data component; and
a modifier to the multiple choices user-selection, wherein a modification of the multiple choices provides at least a part of the response data component.

11. The processor-implemented method according to claim 10, wherein the multiple choices user-selection and the modifier correspond to a state of the patient.

12. The processor-implemented method according to claim 10, wherein the modifier is an input provided by the patient or a user related to the patient.

13. The processor-implemented method according to claim 9, wherein the reminder comprises one or more of:
a reminder to acknowledge the notification message, wherein the acknowledgement, when acquired, provides at least a part of the response data component; and
a request for a best time to send a future notification message or the optional one or more follow-up notification message, wherein the best time, when acquired, provides at least a part of the response data component.

14. The processor-implemented method according to claim 9, wherein the notification message comprises a new information notification providing information of education materials or visit plans for the patient, wherein a further request for the new information forms at least a part of the response data component.

15. The processor-implemented method according to claim 9, wherein the request comprises a request for the patient to participate in activities prescribed in the administered engagement plan.

16. The processor-implemented method according to claim 1, wherein the response message comprises a multi-media component.

17. The processor-implemented method according to claim 16, wherein the multi-media component is an image or a video corresponding to the patient.

18. The processor-implemented method according to claim 16, wherein the multi-media component is an image, video, or a Universal Product Code (UPC) corresponding to one or more of: an ingested substance, a topically applied substance, or an ingested food item.

19. The processor-implemented method according to claim 1, wherein the second processor-based device is one of a smartphone, a computer, a tablet computer, a wearable computer, and a netbook.

20. The processor-implemented method according to claim 1, wherein the first processor-based device is one or more computers with data interconnections therebetween.

21. The processor-implemented method according to claim 5, wherein the first processor-based device or the third processor-based device is
a computer; or
one or more computers with data interconnections therebetween.

22. The processor-implemented method according to claim 1, wherein, the administering time is a time that is defined by the engagement protocol and is further adjusted according to the engagement plan.

23. The processor-implemented method according to claim 1, further comprising:
receiving, by the first processor-based device, one or more follow-up response messages in response to the optional one or more follow-up notification messages;
receiving, by the engagement software application executing on the first processor-based device, a follow-up status corresponding to each of the optional one or more follow-up notification messages and each of the one or more follow-up response messages; and
determining, by the engagement software application executing on the first processor-based device, follow-up patient parameters in accordance with the one or more follow-up response messages and each follow-up status, the follow-up patient parameters amending the patient parameters.

24. The processor-implemented method according to claim 23, wherein each follow-up status corresponds to the one or more of:
a follow-up receipt time corresponding to time of receipt of each follow-up response message at the first processor-based device;
a first difference of follow-up time between the transmission of each optional follow-up notification message and the receipt of each corresponding follow-up response message;
a second difference of follow-up time between the transmission of each optional follow-up notification message and any subsequent follow-up notification message;
a third difference of follow-up time between the transmission of each optional follow-up notification message and the lack of the corresponding follow-up response message; and
a follow-up administering time corresponding to the time of transmission of each optional follow-up notification message.

25. The processor-implemented method according to claims 1, 2, 3, or 8, wherein the status corresponds to the one or more of:
a receipt time corresponding to time of receipt of the response message at the first processor-based device;
a first difference of time between the transmission of the notification message and the receipt of the response message;
a second difference of time between the transmission of the notification message and the optional one or more follow-up notification messages;
a third difference of time between the transmission of the notification message and the lack of the response message; and
the administering time corresponding to the time of transmission of the notification message.

26. The processor-implemented method according to claims 24 or 25,
wherein one or both of the status or each follow-up status is processed using a pattern recognition software on the first processor-based device, and
wherein a pattern of responses is generated by the pattern recognition software and in accordance with one or more of the receipt time, the first difference of time, the second difference of time, the third difference of time, and the administering time; and
wherein the pattern of responses is generated optionally in accordance with one or more of the follow-up receipt time, the first difference of follow-up time, the second difference of follow-up time, the third difference of follow-up time, and the follow-up administering time.

27. The processor-implemented method according to claim 26, wherein the pattern of responses determine either a retention or a change in the administering time and each of the follow-up administering times.

28. The processor-implemented method according to claim 26, wherein the pattern of responses determines a time compliance patient parameter that corresponds to a determination that the patient is in compliance with the administered engagement plan.

29. The processor-implemented method according to claim 26, wherein the pattern recognition software comprises one or more of a classification software, a correlation software, and a clustering software.

30. The processor-implemented method according to claim 29, wherein the pattern recognition software comprises a discriminant analysis software, a decision tree software, a Bayesian test software, or a k-means clustering software.

31. The processor-implemented method according to claim 4, wherein the compliance patient parameter includes a diet compliance parameter and a treatment compliance parameter, each in accordance with the administered engagement plan.

32. The processor-implemented method according to claim 1, wherein the administering time for administering the engagement plan corresponds to a contextual schedule.

33. The processor-implemented method according to claim 32, wherein the contextual schedule includes triggering the administering time when one of a pollen count, a pollution level, or a weather pattern, each as generated from a weather prediction source, is detected as being harmful to the medical condition of the patient.

34. A processor-implemented system for eliciting patient engagement corresponding to an engagement plan administered to the patient, the processor-implemented system comprising:
a builder software application executing on a first processor-based device for creating the engagement plan corresponding to the patient by customizing an engagement protocol from a database of engagement protocols, each of the engagement protocols relating to a type of medical condition;
an engagement software application executing on the first processor-based device for monitoring the engagement plan relating to the patient to determine that an administering time for administering the engagement plan has been reached;
the engagement software application executing on the first processor-based device for generating a notification message for a notification server queue when it is determined that the administering time has been reached, wherein the notification message corresponds to the engagement protocol of the engagement plan;
the notification server queue for transmitting the notification message to a registered second processor-based device, the notification message comprising an interactive software component for receiving a response message from the second processor-based device, wherein the response message or a lack of the response message optionally initiates one or more follow-up notification messages to be sent to the second processor-based device;
the engagement software application executing on the first processor-based device for receiving the response message and a status corresponding to the notification message and the response message; and
the engagement software application executing on the first processor-based device for determining patient parameters in accordance with the response message and the status, thereby eliciting patient engagement corresponding to the engagement plan.

35. The processor-implemented system according to claim 34, further comprising:
the first processor-based device for analyzing the status to determine a validity patient parameter corresponding to the validity of the response message prior to determining the patient parameters.

36. The processor-implemented system according to claims 34 or 35, wherein the status is extracted from
a meta-data component of the notification message and the response message; or
the first processor-based device configured for monitoring the notification message and the response message.

37. The processor-implemented system according to claim 34, further comprising:
the first processor-based device for analyzing a response data component of the response message to determine a compliance patient parameter to determine that the patient is in compliance with the administered engagement plan.

38. The processor-implemented system according to claim 34, further comprising:
a web-based application executing on a third processor-based device or the first processor-based device for receiving a selection for the engagement protocol from one or more engagement protocols, the selected engagement protocol corresponding to the engagement plan and provided as the engagement protocol that is determined by the first processor-based device.

39. The processor-implemented system according to claim 38, wherein the one or more engagement protocols correspond to one or more different health conditions.

40. The processor-implemented system according to claim 38, wherein the one or more engagement protocols correspond to one or more previously administered engagement plans.

41. The processor-implemented system according to claim 34, wherein the optional one or more follow-up notification messages correspond to one or more of: the response data component and the status of the response message from the meta-data component.

42. The processor-implemented system according to claim 34, wherein the notification message and the optional one or more follow-up notification messages comprise one or more of: a query, a reminder, a notification, and a request.

43. The processor-implemented system according to claim 42, wherein the query comprises one or more of:
a request for acknowledgment of the notification message, wherein the acknowledgement, when acquired, provides at least a part of the response data component;
a multiple choices user-selection, wherein a selection from the multiple choices provides at least a part of the response data component; and
a modifier to the multiple choices user-selection, wherein a modification of the multiple choices provides at least a part of the response data component.

44. The processor-implemented system according to claim 43, wherein the multiple choices user-selection and the modifier correspond to a state of the patient.

45. The processor-implemented system according to claim 43, wherein the modifier is an input provided by the patient or a user related to the patient.

46. The processor-implemented system according to claim 42, wherein the reminder comprises one or more of:
a reminder to acknowledge the notification message, wherein the acknowledgement, when acquired, provides at least a part of the response data component; and
a request for a best time to send a future notification message or the optional one or more follow-up notification message, wherein the best time, when acquired, provides at least a part of the response data component.

47. The processor-implemented system according to claim 42, wherein the notification message comprises a new information notification providing information of education materials or visit plans for the patient, wherein a further request for the new information forms at least a part of the response data component.

48. The processor-implemented system according to claim 42, wherein the request comprises a request for the patient to participate in activities prescribed in the administered engagement plan.

49. The processor-implemented system according to claim 34, wherein the response message comprises a multi-media component.

50. The processor-implemented system according to claim 49, wherein the multi-media component is an image or a video corresponding to the patient.

51. The processor-implemented system according to claim 49, wherein the multi-media component is an image, a video, or a Universal Product Code (UPC) corresponding to one or more of: an ingested substance, a topically applied substance, or an ingested food item.

52. The processor-implemented system according to claim 34, wherein the second processor-based device is one of a smartphone, a computer, a tablet computer, a wearable computer, and a netbook.

53. The processor-implemented system according to claim 34, wherein the first processor-based device is one or more computers with data interconnections therebetween.

54. The processor-implemented system according to claim 38, wherein the first processor-based device or the third processor-based device is
a computer; or
one or more computers with data interconnections therebetween.

55. The processor-implemented system according to claim 34, wherein, the administering time is a time that is defined by the engagement protocol and is further adjusted according to the engagement plan.

56. The processor-implemented system according to claim 34, further comprising:
the first processor-based device for receiving one or more follow-up response messages in response to the optional one or more follow-up notification messages;
the engagement software application for receiving on the first processor-based device, a follow-up status corresponding to each of the optional one or more follow-up notification messages and each of the one or more follow-up response messages; and
the engagement software application executing on the first processor-based device for determining follow-up patient parameters in accordance with the one or more follow-up response messages and each follow-up status, the follow-up patient parameters amending the patient parameters.

57. The processor-implemented system according to claim 56, wherein each follow-up status corresponds to the one or more of:
a follow-up receipt time corresponding to time of receipt of each follow-up response message at the first processor-based device;
a first difference of follow-up time between the transmission of each optional follow-up notification message and the receipt of each corresponding follow-up response message;
a second difference of follow-up time between the transmission of each optional follow-up notification message and any subsequent follow-up notification message;
a third difference of follow-up time between the transmission of each optional follow-up notification message and the lack of the corresponding follow-up response message; and
a follow-up administering time corresponding to the time of transmission of each optional follow-up notification message.

58. The processor-implemented system according to claims 34, 35, 36, or 41, wherein the status corresponds to the one or more of:
a receipt time corresponding to time of receipt of the response message at the first processor-based device;
a first difference of time between the transmission of the notification message and the receipt of the response message;
a second difference of time between the transmission of the notification message and the optional one or more follow-up notification messages;
a third difference of time between the transmission of the notification message and the lack of the response message; and
the administering time corresponding to the time of transmission of the notification message.

59. The processor-implemented system according to claims 57 or 58,
wherein one or both of the status and each follow-up status are processed using a pattern recognition software on the first processor-based device, and
wherein a pattern of responses is generated by the pattern recognition software and in accordance with one or more of the receipt time, the first difference of time, the second difference of time, the third difference of time, and the administering time; and
wherein the pattern of responses is generated optionally in accordance with one or more of the follow-up receipt time, the first difference of follow-up time, the second difference of follow-up time, the third difference of follow-up time, and the follow-up administering time.

60. The processor-implemented system according to claim 59, wherein the pattern of responses determine either a retention or a change in the administering time and each of the follow-up administering times.

61. The processor-implemented system according to claim 59, wherein the pattern of responses determines a time compliance patient parameter that corresponds to a determination that the patient is in compliance with the administered engagement plan.

62. The processor-implemented system according to claim 59, wherein the pattern recognition software comprises one or more of a classification software, a correlation software, and a clustering software.

63. The processor-implemented system according to claim 62, wherein the pattern recognition software comprises a discriminant analysis software, a decision tree software, a Bayesian test software, or a k-means clustering software.

64. The processor-implemented system according to claim 37, wherein the compliance patient parameter includes a diet compliance parameter and a treatment compliance parameter, each in accordance with the administered engagement plan.

65. The processor-implemented method according to claim 34, wherein the administering time for administering the engagement plan corresponds to a contextual schedule.

66. The processor-implemented method according to claim 65, wherein the contextual schedule includes triggering the administering time when one of a pollen count, a pollution level, or a weather pattern, each as generated from a weather prediction source, is detected as being harmful to the medical condition of the patient.
